(19) United States
(12) Patent Application Publication
(10) Pub. No.: US 2015/0118582 A1
(43) Pub. Date: Apr. 30, 2015

(54) NON-CARBON BASED LITHIUM-AIR ELECTRODE

(71) Applicants: CORNING INCORPORATED, CORNING, NY (US); SHANGHAI INSTITUTE OF CERAMICS, CHINESE ACADEMY OF SCIENCES, SHANGHAI (CN)

(72) Inventors: Michael Edward Badding, Campbell, NY (US); Chen Shen, Shanghai (CN); Yanming Cui, Ningbo (CN); Zhaoyin Wen, Shanghai (CN)

(21) Appl. No.: 14/517,105

(22) Filed: Oct. 17, 2014

(30) Foreign Application Priority Data
Oct. 31, 2013 (CN) 201310534287.1

(51) Int. Cl. H01M 4/86; H01M 12/02; H01M 4/88; H01M 12/00

(52) U.S. Cl. CPC H01M 4/8605; H01M 12/00; H01M 12/02; H01M 4/8875
USPC 429/403; 429/517; 429/519; 429/522; 252/518.1; 252/520.1

(57) ABSTRACT

A cathode current collector for a lithium-air battery includes a carbon-free, conductive, porous matrix. The matrix may include a metal boride, a metal carbide, a metal nitride, a metal oxide and/or a metal halide. Example matrix materials are antimony-doped tin oxide and titanium oxide. A carbon-free cathode exhibits improved mechanical and electrochemical properties including improved cycle life relative to conventional carbon-containing porous cathode current collectors.

### CROSS-REFERENCE TO RELATED APPLICATIONS

This application claims the benefit of priority of Chinese Patent Application Serial No. 201310534287.1 filed on Oct. 31, 2013, the entire content of which is hereby incorporated by reference.

### BACKGROUND

1. Field

The present disclosure relates generally to lithium-air batteries, and more particularly to electrode designs for use in such batteries.

2. Technical Background

A lithium-air battery includes a metal-air battery chemistry that uses the oxidation of lithium at the anode and reduction of oxygen at the cathode to induce a current flow. Lithium-air batteries have been the subject of recent research due to the high energy density that they can store. The improvement in the energy density over conventional batteries is primarily achieved by using atmospheric oxygen as a source of fuel rather than storing an oxidizer internally.

Lithium metal is a conventional choice for the anode material in Li-air batteries. At the anode, lithium oxidizes under an electrochemical potential and gives off an electron according to the half-cell reaction Li [symbol] Li⁺+e⁻. Conversely, at the cathode reduction occurs by the recombination of lithium ions with oxygen. Mesoporous carbon materials are conventionally used for the cathode material, i.e., cathode current collector. In cells using aprotic electrolytes, reduction at the cathode can be described by the half-cell reaction Li⁺+e⁻+O₂ [symbol] Li₂O₂.

A challenge to the successful implementation of non-aqueous carbon cathode-based Li-air batteries is the insolubility of the lithium oxide reaction products. For instance, lithium peroxide, Li₂O₂, may be observed as the reaction product. Accumulation of lithium reaction products creates a mass diffusion barrier in the cathode structure which can eventually inhibit the reaction kinetics of the battery.

A further obstacle to cathode-based Li-air batteries is the large polarization encountered during cycling. This large cell polarization may be due to the high activation energy required to produce Li₂O₂ during discharging and to decompose the Li₂O₂ reaction product during charging.

In view of the foregoing, a mechanically and chemically robust cathode for oxygen reduction and oxygen evolution reaction in Li-air batteries is highly desirable.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF SUMMARY

A cathode such as for a lithium-air battery comprises a carbon-free, conductive, porous matrix. The matrix may be formed from at least one compound selected from the group consisting of a boride, carbide, nitride, oxide and halide. Example compounds include tin oxide and titanium oxide such as antimony-doped tin oxide or a titanium sub-oxide. The porous matrix may be formed from partially-coalesced particles such as spherical, oblong, fibrous, rod-like or tubular particles.

In accordance with embodiments of the present disclosure, the matrix material may have a conductivity of 10⁻⁸ to 10⁸ S/cm, and a specific surface area of 10⁻³ to 10⁵ m²/g.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic of an example lithium-air battery;

FIG. 2 is a TEM image of VXC-72 carbon material according to Comparative Examples 1 and 2;

FIG. 3 is a TEM image of Sb-doped SnO₂ material according to Examples 1 and 2;

FIG. 4 is an XRD scan of Sb-doped SnO₂ material according to Examples 1 and 2;

FIG. 5 shows TG-DSC profiles of comparative VXC-72 carbon material and Sb-doped SnO₂ material;

FIG. 6 shows electrolyte wetting angle data for (a) comparative VXC-72 carbon material and (b) Sb-doped SnO₂ material;

FIG. 7 are first discharge/charge profiles for cells including comparative VXC-72 carbon material and Sb-doped SnO₂ material at low current;

FIG. 8 shows three discharge/charge cycles for Sb-doped SnO₂-based cells at low current;

FIG. 9 are first discharge/charge profiles for cells including comparative VXC-72 carbon material and Sb-doped SnO₂ material at high current;

FIG. 10 shows first discharge/charge profiles for Sb-doped SnO₂-based cells at various current densities; and

FIG. 11 is a plot of specific capacity versus cycle number for comparative VXC-72 carbon-based cells and Sb-doped SnO₂-based cells.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

A cathode current collector for a lithium-air battery comprises a carbon-free, conductive, porous matrix. Device performance can be improved by omission from the cathode of elemental carbon, which is oleophilic and exhibits a relatively low polarity. For instance, lithium-air batteries with carbon-containing cathodes cannot discharge under large currents and have limited cycle performance due in part to oxidation of the carbon during operation.

The disclosed structures are electrically conductive, oleophobic, mechanically and electrochemically stable and can deliver high cycle life and high capacity at an economical cost. The mechanical strength and stability, for example, can relieve pore expansion during sustained deposition of discharge products and keep the three-dimensional pore structure from collapsing, thus improve cycling stability of the battery. In the freestanding porous cathodes of the present disclosure, there is sufficient void volume for Li₂O₂ storage.

Though the matrix is free of elemental carbon, e.g., activated carbon, graphitic carbon and the like, the matrix may include a carbon-containing compound, such as a carbide compound. In embodiments, the matrix may comprise a conductive boride, a conductive carbide, a conductive nitride, a conductive oxide, a conductive halide or a combination thereof. Such a boride, carbide, nitride, oxide or halide may be formed from a metallic or non-metallic cation, and can be represented by respective formulas MB, MC, MN, MO or MX, where X is a halide. The metallic or non-metallic cation (M) may be one or more elements from the first column to the sixteenth column of the Periodic Table of the Elements.

Particular example oxides include tin oxide and titanium oxide. An oxide may be a stoichiometric oxide or a non-stoichiometric oxide. Titanium oxide, for example, includes stoichiometric TiO₂-type oxides, such as an anatase or rutile, and sub-stoichiometric oxides such as TiO₂, (0<x<2), e.g., Ti₄O₇.

The porous matrix may comprise an aggregate of particles. Such particles, which comprise the boride, carbide, nitride, oxide and/or halide, may have a morphology characterized by one or more of spherical, oblong, fibrous, rod-like or tubular. The attendant geometry provides abundant surface area for electrochemical reactions and volume for accumulation of discharge products.

A characteristic dimension (e.g., diameter or length) of individual particles may range from 0.1 nm to 10⁵ nm, e.g., 1 to 10⁴ nm. For example, spherical particles may have a diameter ranging from 0.1 to 10⁵ nm. The particles may be porous.

The matrix may have a conductivity, e.g., ionic conductivity, of 10⁻⁸ to 10⁸ S/cm. The conductivity may be equal to, or range between any two values chosen from 10⁻⁸, 10⁻⁷, 10⁻⁶, 10⁻⁵, 10⁻⁴, 10⁻³, 10⁻², 10⁻¹, 1, 10, 10², 10³, 10⁴, 10⁵, 10⁶, 10⁷ and 10⁸. The non-carbon-based conductive compound Compared to conventional carbon-based cathodes, the non-carbon-based cathodes have a higher electronic conductivity, which provides more electron transfer paths in a conductive network and thus reduces the battery resistance.

The matrix may have a BET specific surface area of 10⁻³ to 10⁵ m²/g, for example, 1 to 10⁴ m²/g.

As used herein, oleophobic means that a contact angle between the cathode current collector, i.e., the porous matrix, and an organic electrolyte at 25° C. is between 5° and 155°. For example, the contact angle may range from 30° to 100°. By providing a large contact (i.e., wetting) angle, flooding of the cathode by the electrolyte can be minimized and a large reaction area is provided, which can increase the specific capacity of the battery especially under high current densities.

In embodiments, the matrix may include one or more dopants as a trace impurity. In the case of a crystalline carbon-free, conductive, porous material, dopant atoms may substitute for atoms that were in the crystal lattice of the material. However, an amorphous carbon-free, conductive, porous material can also be doped with impurities to affect its properties. For instance, the addition of a dopant can increase the electronic conductivity of the carbon-free, conductive, porous material.

Example dopants include metals and semi-metals such as boron, aluminum phosphorus, gallium, germanium, arsenic and antimony.

The cathode current collector may include a binder. The binder may be water soluble or oil soluble. Example binders include polytetrafluoroethylene (PTFE) and polyvinylidene fluoride (PVDF).

The non-carbon-based conductive porous matrix may demonstrate catalytic activity in-situ, further reducing a battery's over-potential. Metal catalysts, for example, can be incorporated into the cathode to enhance the oxygen reduction kinetics and increase the specific capacity of the cathode. Specifically, the addition of catalytic materials can improve the discharge/charge efficiencies and affect the re-chargeability of the cells. However, only limited success has been achieved with respect to both insolubility and high polarization. Further, in conventional approaches where catalysts are incorporated into porous carbon cathodes by mechanical mixing, it is difficult to ensure both a uniform dispersion of the catalyst sites and sufficient contact between the catalyst material and the underlying support.

Particles of a catalyst may be incorporated into the carbon-free, conductive, porous material. Vanadium, manganese, iron, cobalt, nickel, ruthenium, rhodium, palladium, silver and platinum, or compounds thereof (e.g., V₂O₅ or MnO₂) may be used as catalysts. Metal, metal organic or metal oxide catalysts optionally incorporated into the porous structure of the cathode may enhance the oxygen reduction kinetics and increase the specific capacity of the cathode.

An aqueous lithium-air battery includes a lithium metal anode and a porous cathode and uses the oxidation of lithium at the anode and reduction of oxygen at the cathode to induce a current flow. When an externally applied potential is greater than the standard potential for the discharge reaction, lithium metal is plated out on the anode, and O₂ is generated at the cathode. Atmospheric oxygen may react at the cathode, but contaminants such as water vapor can damage the matrix.

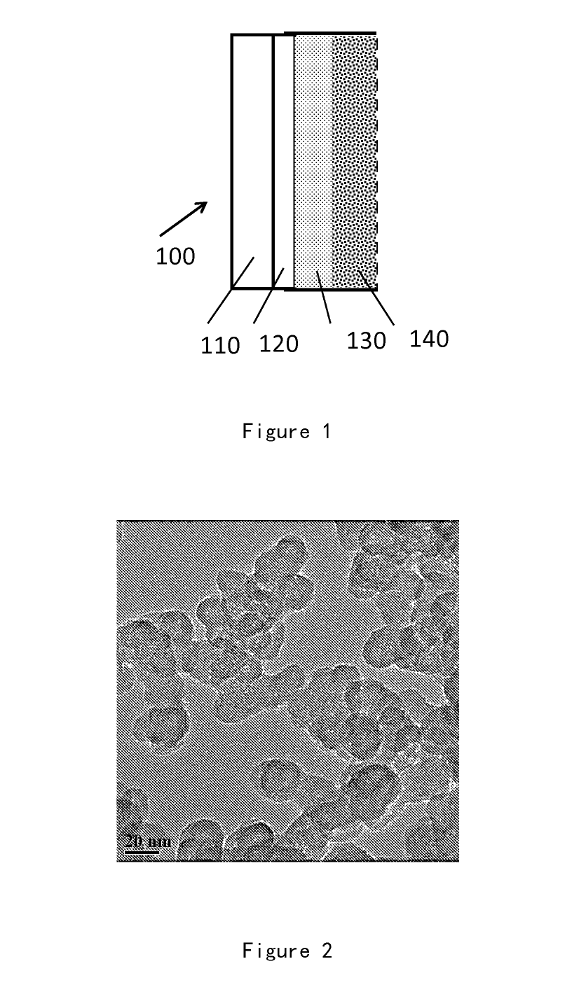

A schematic of an example lithium-air battery is shown in FIG. 1. The battery 100 includes a lithium metal anode 110, a solid electrolyte 120, a liquid electrolyte 130, and a cathode 140. The cathode 140 may be a cathode current collector as disclosed herein. Example liquid electrolytes include a lithium salt dissolved in an organic solvent. The solid electrolyte 120 may be in direct physical contact with the anode 110 or, in a non-illustrated embodiment, the a liquid electrolyte (i.e., anolyte) may be provided at the interface between the anode 110 and the solid electrolyte 120.

At the cathode 140, reduction occurs by the recombination of lithium ions with oxygen. In particular, electrochemical reactions at the cathode take place at three phase boundaries, which include oxygen (gas phase), electrolyte (liquid phase) and porous cathode matrix (solid phase). In a conventional carbon-supported air electrode (normally a composite of carbon, catalyst and binder), the practical capacity is influenced by not only the available porosity of the air electrode, but also the occlusion of the catalytic sites by the formation of Li₂O₂. With reduction, extensive nucleation of the products on the catalysts will block the catalytic sites, and with oxidation, the poor contact between the discharge product and the catalyst will inhibit re-chargeability. In embodiments, the porous matrix obviates incomplete discharge due to blockage of the cathode with discharge product.

In example Li-air cells without a catalyst incorporated into the cathode, the first charge-discharge capacity at 0.02 mA/cm² is as high as 3150 mAh/g. The corresponding discharge voltage is 2.93V (compared to a theoretical value of 2.96V) and the charging voltage is 3.27V.

In the limit capacity mode discharge/charge process, almost no changes in the charge and discharge voltage values were observed over three cycles, consistent with the high stability and activity of the carbon-free, conductive, porous matrix.

For a current density of 0.1 mA/cm², the first charge-discharge capacity is as high as 2870 mAh/g, and the charge-discharge capacity after five cycles is 2750 mAh/g. For a current density of 1 mA/cm², the first charge-discharge capacity is 1100 mAh/g. The discharge voltage is 2.7V and the charging voltage is 3.6V.

In addition to their mechanical stability, the disclosed cathode current collectors are thermally and electrochemically stable and are resistant to oxidation and corrosion. In embodiments, during operation of a lithium-air battery comprising the cathode current collectors, the cathode does not induce or otherwise participate in any non-lithium-air side reactions.

An aqueous route can be used to form a carbon-free, conductive, porous cathode current collector. In an example synthesis, a metal salt (e.g., SnCl₄, SbCl₃, etc.) is initially dissolved in an acid. A basic aqueous solution is added to the acid solution under reflux conditions (e.g., 90° C.) to form a precipitate. The basic solution can include, for example, a solution comprising NaOH and water. The precipitate can be collected, dried and calcined to form an oxide (e.g., antimony-doped tin oxide). An example calcination temperature is 300-500° C. The oxide powder can be combined with a binder and formed into a porous, carbon-free electrode.

Morphologies of the synthesized electrodes were observed using a field emission scanning electron microscope (FESEM JSM-6700F) and a transmission electron microscope (TEM JEM-2100F). Crystalline structure was characterized by powder x-ray diffraction, using a Rigaku Ultima diffractometer employing nickel-filtered Cu-K_{□} radiation. FTIR measurements were carried out on a Fourier Transform Infrared Spectroscope (Tensor 27) in transmission with a KBr pellet. Surface area was determined by BET (Brunauer-Emmett-Teller) measurements using a Tristar 3000 surface area analyzer.

### EXAMPLES

### Comparative Example 1

A commercially-available porous carbon, VXC-72 (Vulcan XC72) was used as the electrode support. The carbon morphology includes an average particle size of about 20 nm and a BET surface area of 208 m²/g. The wetting angle of the VXC-72 carbon with 1M lithium trifluoromethanesulfonimide (LiTFSI) in dimethoxyethane (DME) is 2°. A TEM micrograph of the VXC-72 carbon is shown in FIG. 2.

The porous cathode was formed by casting a slurry mixture of the VXC-72 carbon and polyvinylidene fluoride (PVDF) binder onto a cathode current collector.

Electrochemical cells used to investigate Li—O₂ cycling performance were based on a Swagelok cell design, which includes a Li metal anode (14 mm diameter, 0.25 mm thick), an organic electrolyte, a Celgard 2400 separator, and the as-prepared cathode. The electrolyte is 1M lithium trifluoromethanesulfonimide (LiTFSI) in dimethoxyethane (DME), which was dried with molecular sieves prior to use.

Individual cells were assembled in a glove box with oxygen and water contents less than 1 ppm. To avoid complications related to H₂O and CO₂ contamination, the cells were tested in 1 atm of flowing pure O₂ rather than in ambient air. Except for the cathode side that was exposed to the flowing O₂, the cells were gas-tight.

Galvanostatic charge and discharge tests were conducted at ambient temperature on a LAND CT2001A battery test system at a current density of 0.02 (or 0.1, 0.2 or 0.3) mA cm⁻² after a 6 h rest period, and with a lower voltage limit of 2.0 V (vs. Li/Li⁺) and an upper voltage limit of 4.5 V (vs. Li/Li⁺). So as to examine the charge process, the discharge steps of the cells were designed to be terminated after discharging for 20 days.

For cycling stability studies, cells were discharged and charged at 0.02 mA cm². In order to minimize the side reactions, in the first cycle, the charge at 0.02 mA cm² was terminated when its capacity was equal to the value in the discharge step. The discharge step at 0.02 mA cm² was designed to be terminated to determine the charging property after a specific capacity of as high as 4000 mAh g⁻¹ was achieved.

Electrochemical impedance spectroscopy of the cells was evaluated using an AC impedance analyzer (Autolab Electrochemical Workstation) over a frequency range of 10⁶ Hz to 10⁻² Hz for the interface investigation of the electrodes in cells during discharge/charge cycles. Specific capacity data were calculated using the mass of supports in the cathodes. Data are shown in Table 1.

### Comparative Example 2

The porous cathode and corresponding cell were obtained and tested using the process described in Comparative Example 1, except the cell was discharged and charged at 0.1 mA/cm².

### Example 1

10.517 g SnCl₄ and 0.342 g SbCl₃ (5 at. % with respect to Sn) are added to 4.6 ml concentrated hydrochloric acid and 50 ml deionized water under magnetic stirring. A solution including 6 g NaOH and 100 g H₂O is added to the Sn—Sb solution slowly. Upon addition of the NaOH, a white precipitate is formed. The suspension is transferred to a three-necked flask to reflux under N₂ in a 90° C. oil bath. The color of the suspension changes from white to yellow during the reflux process. After refluxing for 2 h, the suspension is cooled to 25° C.

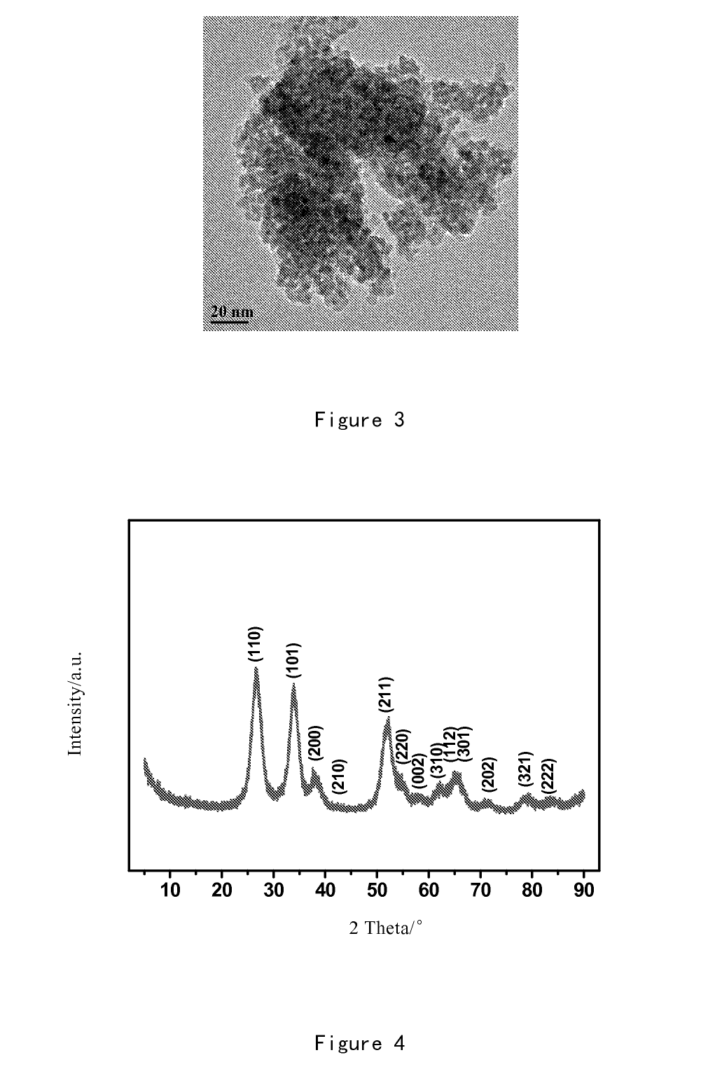

A dark green powder is obtained after centrifugation and drying. A non-carbon-based conductive oxide (Sb—SnO₂) is formed after calcining the green powder at 400° C. for 1 h. The oxide has an average particle size of 5 nm with a specific surface area of 108 m²/g. The oxide conductivity is 0.11 S/cm. The contact angle with LiTFSI/DME electrolyte is 55°. A TEM micrograph of the Sb—SnO₂ powder is shown in FIG. 3, and a corresponding x-ray diffraction scan in shown in FIG. 4. The XRD data index to SnO₂.

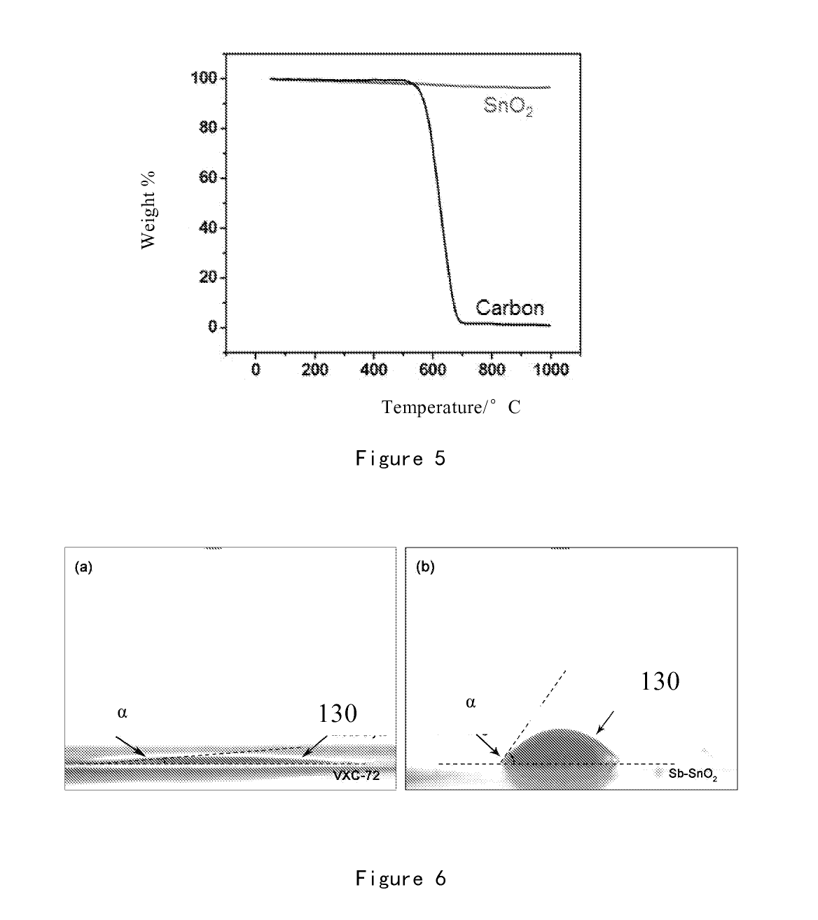

Respective differential scanning calorimetry (DSC) scans for the comparative carbon material and for the tin oxide-based material are plotted in FIG. 5. The data show that the tin oxide is thermally stable up to 1000° C., while the carbon undergoes a significant weight loss at about 600° C. Images showing the contact angle (α) measurements between a drop of the LiTFSI/DME electrolyte 130 and each of the porous carbon and the tin-oxide are shown in FIG. 6(a) and FIG. 6(b), respectively.

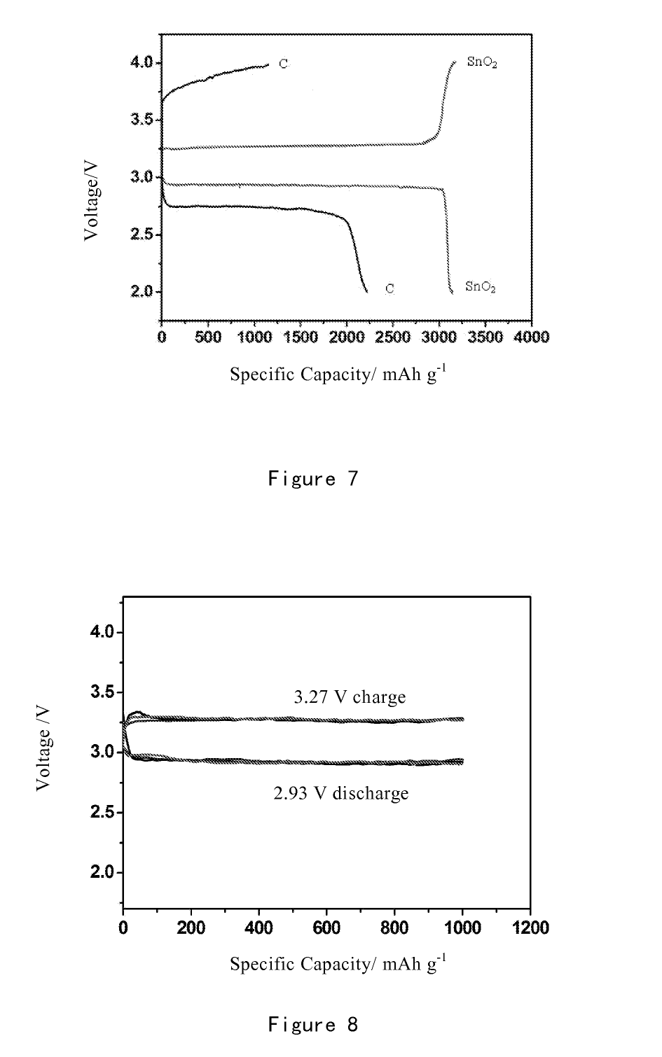

The Sb—SnO₂ powder is mixed with PVDF to prepare an electrode using the method of Comparative Example 1. The resulting battery, also formed by the Comparative Example 1 method, is tested under a current density of 0.02 mA/cm². First discharge/charge traces at 0.02 mA/cm² are shown in FIG. 7 comparing the Sb—SnO₂ powder-based cathode with the comparative carbon-based cathode. Results, which are summarized in Table 1, show a significant improvement in charge/discharge performance compared to the carbon-containing Comparative Example 1.

A plot of three successive discharge/charge cycles for cells containing Sb-doped, SnO₂-based cathodes at 0.02 mA/cm² is shown in FIG. 8. The data show no measurable hysteresis.

### Example 2

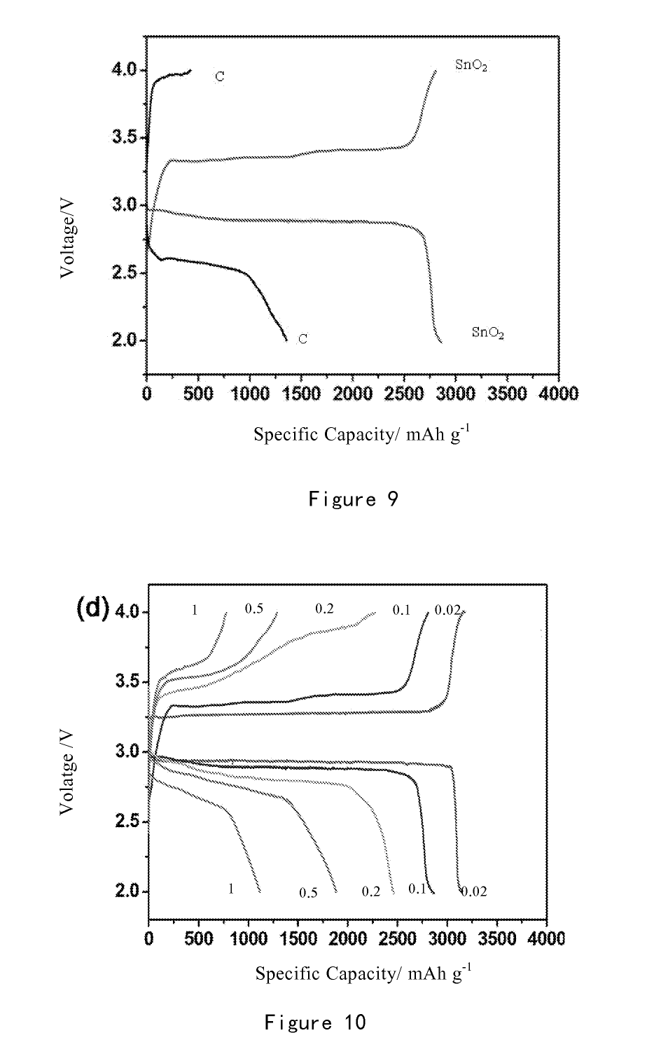

Example 1 is repeated, except the battery is tested under a current density of 0.1 mA/cm². First discharge/charge traces at 0.1 mA/cm² are shown in FIG. 9.

First discharge/charge traces for cells containing Sb-doped, SnO₂-based cathodes at various current densities (0.02, 0.1, 0.2, 0.5 and 1 mA/cm²) are summarized in FIG. 10.

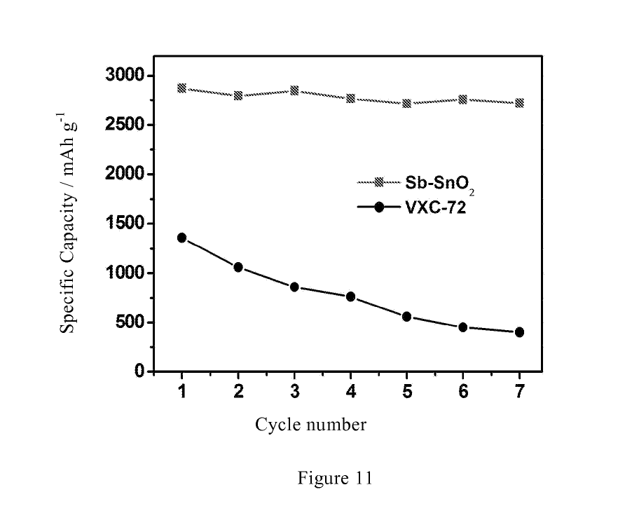

A plot of specific capacity versus cycle number is shown in FIG. 11 for Sb-doped SnO₂-based cathodes and for comparative carbon-based cathodes.

### Example 3

Commercial TiO₂ particles are dried under vacuum at 100° C. for 12 h. The particles are calcined in a reducing (H₂) atmosphere at 1050° C. for 6 h and cooled to 25° C. to form a non-carbon-based conductive oxide, Ti₄O₇.

The Ti₄O₇ has an average particle size of 500 nm with a specific surface area of 50 m²/g. The conductivity is 10³ S/cm, and the contact angle of Ti₄O₇ with LiTFSI/DME is 45°.

The prepared Ti₄O₇ is mixed with PVDF to prepare an electrode using the method of Comparative Example 1. The resulting battery, also formed by the Comparative Example 1 method, is tested under a current density of 0.02 mA/cm² over a voltage range of 2-4 V. The non-carbon-based conductive oxide Ti₄O₇ support enhances the charge/discharge performance significantly with respect to the comparative examples.

### Example 4

Example 3 is repeated, except the battery is tested under a current density of 0.1 mA/cm². Results summarized in Table 1 show that the lithium-air battery comprising the non-carbon-based conductive oxide Ti₄O₇ as a support has a very high discharge capacity and voltage, while the charge voltage of the battery is very low.

### Example 5

2.732 g of MoCl₅ is dissolved in 100 ml deionized water, followed by the drop wise addition of 4.557 g tetramethyl ammonium hydroxide (C₄H₁₃NO). A hydrous molybdenum oxide (MoOₓH_{y}) precipitate forms.

The suspension is stirred for 30 min and filtered. The precipitate is dried at 110° C. for 2 h and calcined at 400° C. for 6 h. After the calcination, the MoOₓ powder has an average particle size of 10³ nm, a specific surface area of 0.5 m²/g, and a conductivity of 1 S/cm. The wetting angle of MoOₓ with LiTFSI/DME electrolyte is 45°.

### Example 6

An air cathode comprising conductive tungsten carbide (WC) is prepared by sputtering tungsten carbide from a tungsten carbide target onto a current collector at a pressure of 10⁻⁴ Pa. A pre-sputtering procedure is used to minimize contaminants in the sputtered material prior to sputtering onto the current collector.

The sputtered WC has an average particle size of 200 nm and a specific surface area of 30 m²/g. The conductivity is 10⁵ S/cm. The contact angle of WC with LiTFSI/DME electrolyte is 40°.

### Example 7

An air cathode comprising titanium boride is prepared. A 1:2 (molar ratio) mixture of Ti powder and B powder is ball milled. The resulting powder is pressed into a disk and heated to the melting point of titanium to form TiB₂. The TiB₂ has an average particle size of 100 nm, a specific surface area of 10 m²/g, and a conductivity of 10⁴S/cm. The contact angle of TiB₂ with LiTFSI/DME electrolyte is 43°.

### Example 8

Co powder is calcined at 1000° C. in N₂ for 24 h to form CoN having an average particle size of 1 nm and a specific surface area of 60 m²/g. The conductivity of the CoN powder is 10³ S/cm. The contact angle of CoN with LiTFSI/DME electrolyte is 55°.

### Example 9

Ta powder is calcined at 800° C. under N₂ and O₂ for 24 h to form TaO_{0.92}N_{1.05}. The TaO_{0.92}N_{1.05} has an average particle size of 3 nm and a specific surface area of 20 m²/g. The conductivity of the TaO_{0.92}N_{1.05} powder is 10² S/cm. The contact angle of TaO_{0.92}N_{1.05} with LiTFSI/DME electrolyte is 60°.

### Example 10

A ceramic crucible filled with Sn powder is placed in the center of a tube furnace. A piece of stainless steel mesh is placed within the tube furnace, downstream and 5 cm from the crucible boat. The temperature of the furnace is increased to 950° C. and 10 cm³/min oxygen gas is introduced. After 30 min, the furnace is cooled to 25° C.

Tin oxide wires having a diameter of about 10 nm are formed on the stainless steel mesh. The specific surface area of the SnO₂ nanowires is 100 m²/g. The conductivity of the SnO₂ is 10⁻¹ S/cm. The contact angle of SnO₂ with LiTFSI/DME electrolyte is 50°.

### Example 11

The Sb—SnO₂ compound prepared in the same way described in Example 1.

0.8 g H₂PtCl₆ is dissolved into 200 ml of 0.1 MNaOH ethylene glycol solution. The solution is stirred at 150° C. under inert atmosphere for 50 min and then added to an aqueous suspension of 5 wt. % Sb—SnO₂ from Example 1 and stirred for another 5 h. After adding 2 M H₂SO₄ to neutralize the NaOH, the suspension is filtered and dried to form Pt@Sb—SnO₂ powder. The notation Pt@Sb—SnO₂ refers to “catalyst” @ “substrate.”

TABLE 1
Example Cell Performance

| | | Contact | | Surface | Current | | Capacity, | Capacity, |
|---|---|---|---|---|---|---|---|---|
| | | Angle | Conduct. | Area | Density | Discharge-Charge | 1st | 5th |
| Ex. | Support | [°] | [S/cm] | [m²/g] | [mA/cm²] | [V] | [mAh/g] | [mAh/g] |
| C1 | VXC-72 | 2 | 10² | 207 | 0.02 | 2.75-3.8 | 2223 | |
| C1 | VXC-72 | 2 | 10² | 207 | 0.1 | 2.4-3.95 | 1370 | 500 |
| 1 | Sb—SnO₂ | 55 | 0.11 | 108 | 0.02 | 2.93-3.27 | 3150 | |
| 2 | Sb—SnO₂ | 55 | 0.11 | 108 | 0.1 | 2.85-3.36 | 2870 | 2750 |
| 3 | Ti₄O₇ | 45 | 10³ | 50 | 0.02 | 2.94-3.20 | 4500 | |
| 4 | Ti₄O₇ | 45 | 10³ | 50 | 0.1 | 2.90-3.30 | 3500 | 3000 |

The cathode current collectors disclosed herein may improve the performance of a lithium-air battery. The non-carbon-based conductive compound has a stable three-dimensional porous structure, high specific surface area, low resistance, and may be formed via simple synthesis routes.

Compared to conventional carbon-based cathodes, the non-carbon-based cathodes can provide a large three-phase interface and a thin gas diffusion layer, which improve the practical cell capacity and high rate performance of a lithium-air battery.

As used herein, the singular forms “a,” “an” and “the” include plural referents unless the context clearly dictates otherwise. Thus, for example, reference to a “binder” includes examples having two or more such “binders” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a cathode that comprises a support, a catalyst and a binder include embodiments where a cathode consists a support, a catalyst and a binder and embodiments where a cathode consists essentially of a support, a catalyst and a binder.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

We claim:

1. A cathode current collector for a lithium-air battery comprising a carbon-free, conductive, porous matrix.

2. The cathode current collector according to claim 1, wherein the matrix comprises at least one compound selected from the group consisting of a boride, carbide, nitride, oxide and halide.

3. The cathode current collector according to claim 1, wherein the matrix comprises an oxide selected from the group consisting of tin oxide and titanium oxide.

4. The cathode current collector according to claim 1, wherein the matrix comprises antimony-doped tin oxide or a titanium sub-oxide.

5. The cathode current collector according to claim 1, wherein the matrix comprise spherical, oblong, fibrous, rod-like or tubular particles.

6. The cathode current collector according to claim 1, wherein the matrix has a conductivity of 10⁻⁸ to 10⁸ S/cm.

7. The cathode current collector according to claim 1, wherein the matrix has a surface area of 10⁻³ to 10⁵ m²/g.

8. The cathode current collector according to claim 1, wherein the matrix further comprises particles of a catalyst.

9. The cathode current collector according to claim 8, wherein the catalyst comprises a metal selected from the group consisting of V, Mn, Fe, Co, Ni, Ru, Rh, Pd, Ag and Pt.

10. A lithium-air battery comprising the cathode current collector according to claim 1.

11. The lithium-air battery according to claim 10, wherein the battery comprises an organic electrolyte and a contact angle between the cathode current collector and the electrolyte is 5° to 155°.

12. A method of making a cathode current collector, comprising:
forming an acidic solution comprising a metal compound;
combining a basic solution with the acid solution to form a precipitate;
drying and calcining the precipitate to form an oxide powder;
combining the oxide powder with a binder to form a slurry; and
casting the slurry to form a porous, cathode current collector.

13. The method according to claim 12, wherein the metal compound is selected from the group consisting of tin chloride and antimony chloride.
